(19) United States
(12) Patent Application Publication
(10) Pub. No.: US 2010/0270331 A1
(43) Pub. Date: Oct. 28, 2010

(54) SPICE CONTAINER WITH PIVOTING COVER

(76) Inventors: Katharine Cummins, Deephaven, MN (US); Darren W. Haas, Minnetonka, MN (US)

Correspondence Address: WESTMAN CHAMPLIN & KELLY, P.A., SUITE 1400, 900 SECOND AVENUE SOUTH, MINNEAPOLIS, MN, 55402, US

(21) Appl. No.: 12/634,838

(22) Filed: Dec. 10, 2009

Related U.S. Application Data
(63) Continuation-in-part of application No. 29/335,809, filed on Apr. 22, 2009, now Pat. No. D611770.
(60) Provisional application No. 61/222,694, filed on Jul. 2, 2009.

(51) Int. Cl. B67D 7/78; B65D 47/06; B65D 83/06

(52) U.S. Cl. 222/143; 222/480; 222/533

(57) ABSTRACT

A handheld spice container for dispensing spices has a generally cubic configuration, with walls defining an interior chamber for holding spices. A cover member is pivotally mounted in a top opening, and is pivotable from a closed position in two different pivoting directions. In a first pivoting direction, the cover has a wall forming a shaker portion to permit shaking material from the interior of the container through shaker openings. In a second position of the cover, a chamber which is formed in the cover permits dispensing a quantity of spice contained in the container. The cover is preferably positioned below an upper level of the top wall to form a recess, and the bottom of the container has a boss that will fit into the recess to permit stable stacking one container on top of the other.

### CROSS-REFERENCE TO RELATED APPLICATION

This application claims the benefit of priority of U.S. Provisional Patent Application Ser. No. 61/222,694, filed Jul. 2, 2009, the contents of which is incorporated by reference. This application is a continuation-in-part of co-pending application Ser. No. 29/335,809, filed Apr. 22, 2009.

### FIELD OF THE INVENTION

The present application relates to a container for spices or other particulate materials that can be held in one hand and has a pivoting cover that permit dispensing a measured amount of material such as a spice in one position, and permits use as a shaker for dispensing material in a second position.

Spice containers have been advanced in the prior art, including containers that have flip lids, and some which have screw on covers with flip lids covering shaker openings.

These devices do not combine both the dispensing of a measured amount of material, and also permit movement of a cover or lid between a dispensing position and a shaker position.

### SUMMARY OF THE INVENTION

The present disclosure relates to handheld container for dispensing granular or particulate materials such as ground spice, and which has a pivoting cover that can be operated with one hand to move the cover to a first operable position wherein it will, after being inverted, dispense an amount of product from the container, and in a second operable position provides openings sized for dispensing the material through a shaking action. The container is generally a cube, that is square in cross section and of size for ease of handling, and is designed primarily for use with various spices but other dispensable materials also can be used. The containers are made so that they will stack easily by including a recess at the top just above the pivoting cover, and a mating boss on the bottom, so that they will fit together and be frictionally locked when they are stacked.

Several containers can be stacked, one on top of another in a column, and thus the containers are easy to store in a cupboard. Since the containers are stackable in columns with flat sides, one side of the column can be placed adjacent a side of another column to maximize the utilization of the space in a cupboard or other storage area, such as a shelf in a store.

The containers are easily manufactured from suitable plastics, and can be made in assorted colors, with the names of spices or other material imprinted on the side. Additionally, a sight window can be provided in the side for seeing the level of the material on the interior of the container.

### BRIEF DESCRIPTION OF THE DRAWINGS

FIG. 1 is a perspective view of a container made according to the present disclosure with a movable cover in a position for dispensing a measured quantity of material;

FIG. 2 is a perspective view from an opposite side of the spice container from FIG. 1 with the cover in a shaker position;

FIG. 3 is a top plan view of a spice container of FIGS. 1 and 2 with the cover in a closed position;

FIG. 4 is a bottom plan view of the spice container of the present disclosure;

FIG. 5 is a sectional view taken as on line 5-5 in FIG. 3 showing the cover in a position to dispense a quantity of material in dotted lines;

FIG. 6 is a sectional view taken on the line 6-6 in FIG. 3;

FIG. 7 is a sectional view taken on the same sight line as FIG. 6 with a cover in the position in FIG. 1;

FIG. 8 is a sectional view taken on the same sight line as FIG. 7 with the cover in a shaker position;

FIG. 9 is a fragmentary sectional view showing two of the containers stacked one on top of the other;

### DESCRIPTION OF ILLUSTRATIVE EMBODIMENTS

A container 10 useful for dispensing granular or semi-granular products, such as spices, has a generally cube shape, typically including four side walls 12 of the same dimensions, a top wall 14 and a bottom wall 16 all joined together to form an interior chamber 18 that is of suitable size. However a container with three or more sides is also contemplated.

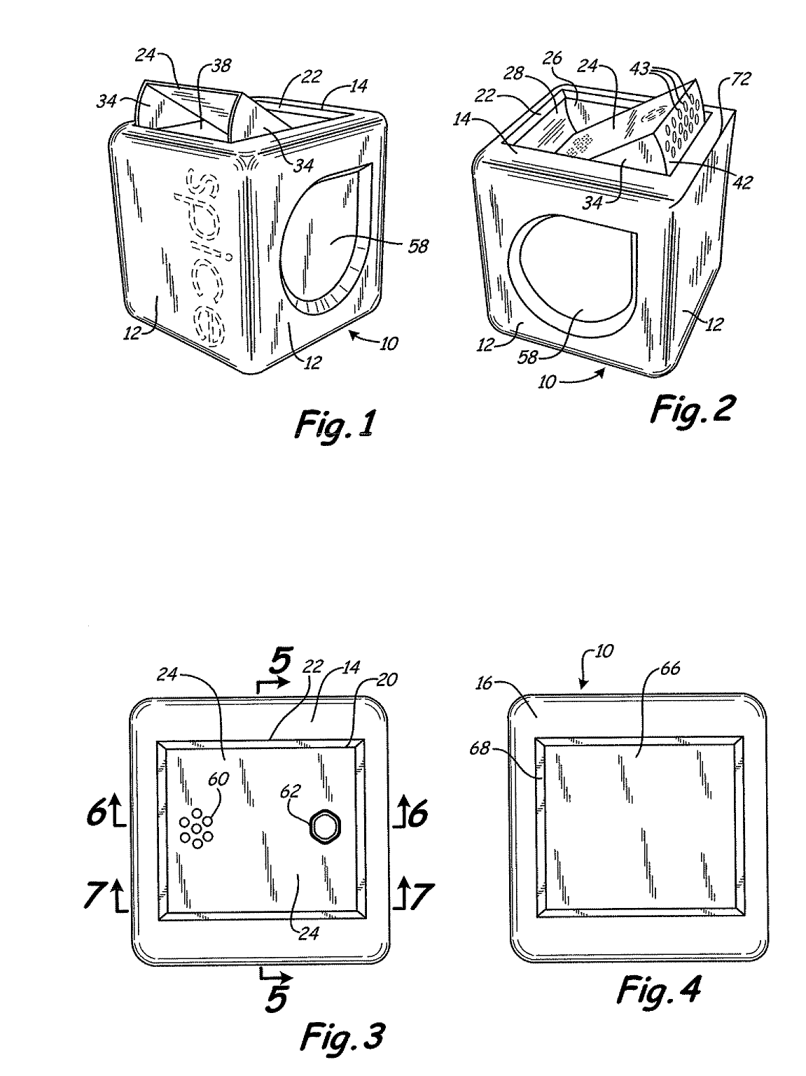

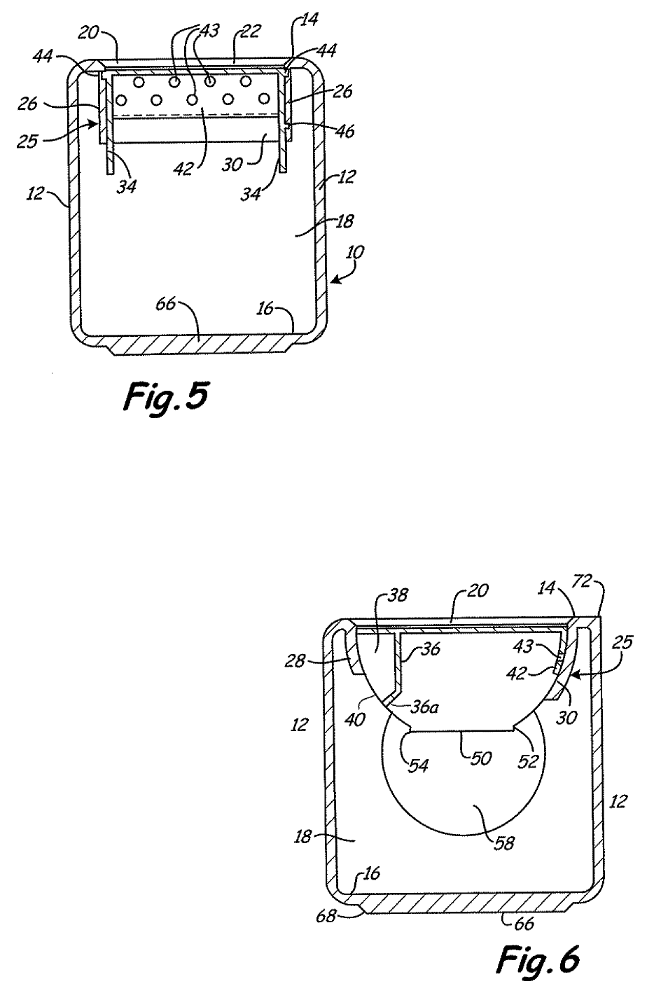

The top wall 14 has a central opening 20, with a beveled or inwardly tapered perimeter edge surface 22. A movable dispensing cover 24 is, as shown, pivotally mounted in the opening, and as shown in FIGS. 5 and 6 is positioned in a cover housing 25 comprising a pair of side guide walls 26, and a first curved, and as shown, part cylindrical end wall 28, and a second curved, and as shown, partial cylindrical end wall 30. The cover, as shown, is mounted so it can pivot about a central axis as shown in FIGS. 1, 2, 6 and 7.

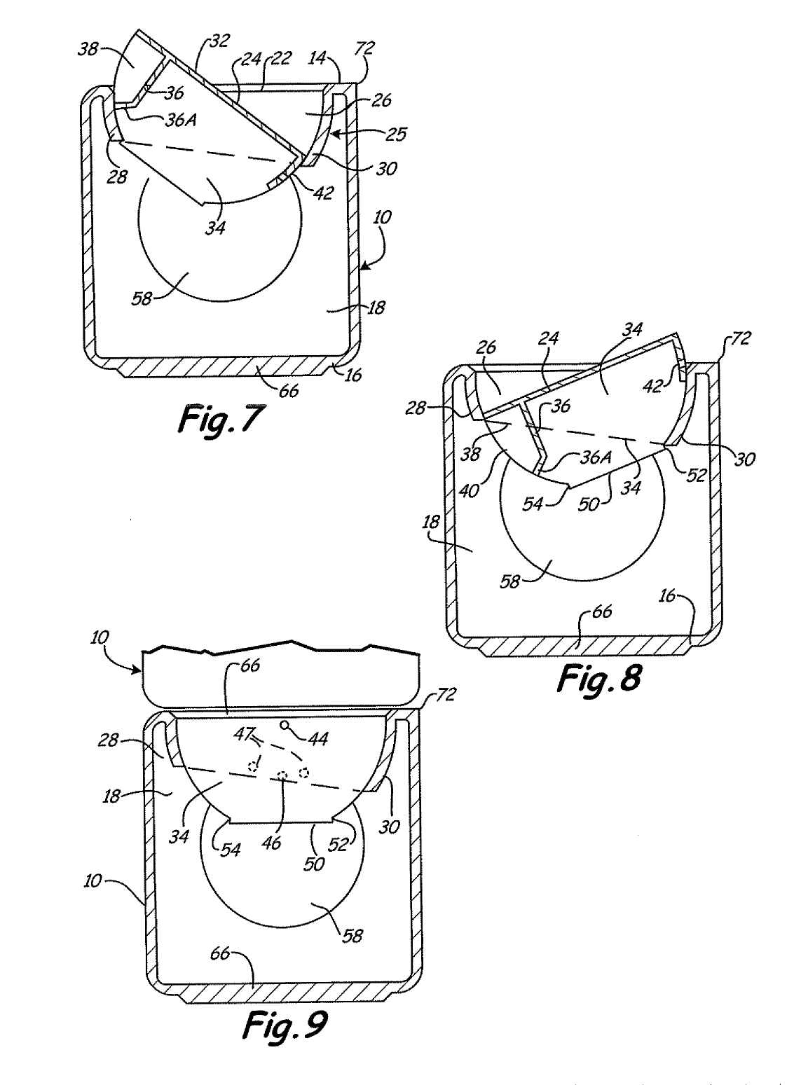

The end walls 28 and 30 of the cover housing 25, as shown are part cylindrical and have curved, as shown, part cylindrical inner or interior surfaces formed on a radius from the pivot axis of the cover 24. The cover 24 has a top wall 32, and side walls 34 that fit between and have exterior surfaces that slide against or contact the interior surfaces of side walls 26 of the cover housing. The cover 24 in addition has a divider wall 36 adjacent one end thereof, and as can be seen, the divider wall 36 extends between the side walls 34 of the pivoting cover, and has an offset wall portion 36A that defines an opening into a dispensing chamber 38. The opening is shown at 40 in FIGS. 6 and 8. The end edge of offset wall portion 36A will wipe against an inner surface of wall 28 when the cover 24 is pivoted to the position shown in FIG. 7. The cover further has an end part cylindrical wall 42 at an opposite end of the cover from the dispensing chamber 38. The wall 42 has an outer surface that mates with and slides against the inner surface of the wall 30 as the cover pivots. The cover 24, as shown, is pivotally mounted with suitable molded pins 44 (FIG. 5) that form a pivot axis and which are received in suitable receptacles or recesses on the side walls 26 of the cover housing. In addition, the side walls 34 of the pivoting cover 24 have detent projections 46 on at least one side wall 34 of the cover 24 that permit the cover to be detented in its closed position and the two pivoted positions. The detent projection engages small recesses shown in dotted lines at 47 in FIG. 9 in the adjacent side wall 26 of the cover housing 25. One or more of the mating walls of the cover housing and cover can be part spherical as well as part cylindrical as long as the cover can be moved to two positions from its closed position.

The pivot pins 44 can be of any desired type, and the cover can be assembled into the cover housing 25 in a suitable manner once the parts have been molded.

Side walls 34 of the cover further have a boss 50 at a lower side thereof, and boss 50 forms stop shoulders or edges 52 and 54 on opposite ends thereof. When the cover is moved to either of its two positions from its center closed position, the respective edges 52 and 54 will act as stops against lower edges of the respective walls 28 and 30.

One or more side walls 12 of the container 10 may optionally have a transparent window 58 formed therein so that an observer can see the level of material, such as a spice or other granular or particulate which is to be dispensed, on the interior chamber 18. The window 58 can be inset, as shown in FIGS. 1 and 2 if desired.

The cover 24 can include indicia shown at 60 and 62 to indicate where to press to obtain desired results. For example, indicia 60 shows shaker openings, and by pushing on that indicia, the cover will be moved to its shaker dispensing position shown in FIG. 7 and when pressing the other dispensing indicia 62, the cover 24 will be moved to the position shown in FIG. 6 which will permit an amount of material to be filled into dispensing chamber 38 to be dispensed as a quantity, without shaking.

The bottom wall 16 has a square boss 66 formed thereon, that has beveled edges 68 that will fit into opening 20 and frictionally engage the tapered edges 22 surrounding the cover, so that as shown in FIG. 9, two or more of the spice containers 10 can be stacked one on top of the other with the interfitting boss 66 received in the recess above the cover 24 with the cover in a closed position.

It can be seen that with the pivoting cover 24 in its closed position such as that shown in FIG. 6 in solid lines, the container 10 can be tilted counterclockwise in that view to fill the dispensing chamber 38 with material, such as spice, under gravity and then the cover can be moved by pivoting it to its position shown in FIG. 6, which will trap material that flows into the compartment 38 after the end of the wall 36A moves past the end 40 of the wall 28. The motion for moving the cover can be done with the forefinger of a hand holding the container 10, and can be done quickly and smoothly, so that the measured amount that filled into chamber 38 remains essentially the same as it is dispensed in one quantity.

It can also be seen that the shaker section of the cover remains closed as the wall 42 remains slidably engaged with the surface of the wall 30.

When spice or other particulate material is to be dispensed through the shaker openings 43, the cover will be moved to its position shown in FIGS. 2 and 8 and the spice or other particulate material can then easily be shaken out through the openings 43 by inverting or partially inverting the container 10 as it is held in one hand.

When the containers 10 are to be stored, they can be stacked one on top of the other as shown in FIG. 9 by pressing the boss 66 on the bottom wall of one container into the recess formed just above the cover of the lower container. The tapered surfaces 22 and 68 will frictionally engage and tend to hold the two containers stable when stacked.

The opening and closing of the cover 24 by pivoting it is easily done with one finger while the container is grasped. The spice container is attractive, easy to use and easy to make.

It should be noted that the corner between the top wall and the side wall adjacent the wall 42 is a sharp corner as indicated at 72. However rounded corners also are contemplated.

Although the present invention has been described with reference to preferred embodiments, workers skilled in the art will recognize that changes may be made in form and detail without departing from the spirit and scope of the invention.

What is claimed is:

1. A dispensing container having walls defining an interior chamber for holding a particulate material, and a top wall of the container having an opening therein, a cover pivotally mounted on the container to cover the opening and movable from a closed position in opposite directions of pivoting to first and second operable positions, a cover housing formed on the container comprising a pair of cover housing side walls and first and second cover housing end walls, the cover having cover side walls and end walls mating with and to an interior of the cover housing side walls and cover housing end walls, the cover side walls and end walls and the cover housing side walls and end walls being curved to permit pivoting the cover, a first cover end wall mating with the first cover housing end wall and having openings exposed when the cover is pivoted to a first position, and a second cover end wall spaced from the second cover housing end wall to form a dispensing chamber open to an interior of the container when the cover is in its closed position, and the second cover end wall having an edge that slides along the second cover housing end wall when the cover is pivoted to its second position thereby closing the dispensing chamber from the interior of the container, and the dispensing chamber opening to an exterior of the container and permitting material in the dispensing chamber to be dispensed with the cover in its second position.

2. The dispensing container of claim 1, wherein at least the first cover end wall and the mating cover housing end wall having mating part cylindrical surfaces.

3. The dispensing container of claim 1 wherein the edge of the second cover end wall is spaced from a edge of the second cover housing end wall to provide an opening of the dispensing chamber to the interior of the container when the cover is in its closed position.

4. The dispensing container of claim 1, wherein the openings in said first cover end wall comprise shaker openings.

5. The dispensing container of claim 1 wherein said container has a generally planar top wall, and said cover having a cover top wall recessed below an upper plane of the top wall of the container when the cover is in its closed position to form an upwardly open recess, and the container having a boss on a lower wall with a periphery configured to fit within the upwardly open recess of a second container with the cover of the second container in its closed position.

6. The dispensing container of claim 1, wherein said container is generally cubic.

7. A dispensing container having walls defining an interior chamber for holding a particulate material, and a top wall of the container having an opening therein, a cover mounted the container to cover the opening and movable from a closed position in opposite directions to first and second operable positions, a cover housing within the chamber, the cover housing having wall portions surrounding the opening with interior surfaces, the cover having cover wall portions with exterior surfaces and positioned in the cover housing, mating with cover housing wall portion interior surfaces, a first cover wall portion having openings exposed when the cover is moved to a first position, and a second cover wall portion forming a dispensing chamber open to an interior of the container when the cover is in its closed position, and the second cover wall portion having an edge that slides along a second cover housing wall portion when the cover is moved to its second position thereby closing the dispensing chamber from the interior chamber of the container with a portion of the dispensing chamber thereby open to an exterior of the container, and permitting material in the dispensing chamber to be dispensed.

8. The dispensing container of claim 7 wherein the edge of a second cover wall portion is spaced from the second cover housing wall portion to provide an opening of the dispensing chamber to the interior of the container when the cover is in its closed position.

9. The dispensing container of claim 7, wherein the openings in said first cover wall portion comprise openings sized to permit material in the interior chamber to be dispensed while shaking the container.

10. The dispensing container of claim 7 wherein said container has a generally planar top wall, and said cover having a top wall recessed below an upper plane of the upper wall when the cover is in its closed position to form an upwardly open recess on an upper side of the container, and the container having a boss on a lower wall with a periphery configured to fit within the upwardly open recess with the cover in its closed position.

11. The dispensing container of claim 7, wherein one wall portion of said container has a transparent portion.

12. A dispensing container having walls defining an interior chamber for holding a particulate material, and a top wall of the container having an opening therein, a cover mounted on the container to cover the opening and movable from a closed position to first and second operable positions, said container having a generally planar top wall, and said cover being recessed below an upper plane of the top wall when the cover is in its closed position to form an upwardly open recess, and the container having a boss on a lower wall with a periphery configured to fit within the upwardly open recess with the cover of the second container in its closed position.
